(19) United States
(12) Patent Application Publication
(10) Pub. No.: US 2014/0376376 A1
(43) Pub. Date: Dec. 25, 2014

(54) Method And Apparatus For Improved Multicast Rate Control

(71) Applicant: Alcatel-Lucent USA Inc., Murray Hill, NJ (US)

(72) Inventors: Yigal Bejerano, Springfield, NJ (US); Katherine H. Guo, Scotch Plains, NJ (US)

(73) Assignee: Alcatel-Lucent USA Inc., Murray Hill, NJ (US)

(21) Appl. No.: 14/310,496

(22) Filed: Jun. 20, 2014

Related U.S. Application Data
(60) Provisional application No. 61/837,528, filed on Jun. 20, 2013.

(51) Int. Cl. H04L 12/825; H04L 12/18

(52) U.S. Cl. CPC H04L 47/263; H04L 12/189
USPC 370/235

(57) ABSTRACT

Various methods and devices are provided to address the need for improved multicast operation. In one method, a sender transmits multicast transmissions at a first transmission rate to a multicast group of mobile devices that includes a group of feedback mobile devices. The sender receives, from each feedback mobile device of the group of feedback mobile devices, multicast receive quality feedback corresponding to the multicast transmissions. A new transmission rate for subsequent multicast transmissions to the multicast group of mobile devices is then determined using the multicast receive quality feedback received from each feedback mobile device, a lower multicast receive quality level threshold and a higher multicast receive quality level threshold.

### REFERENCE(S) TO RELATED APPLICATION(S)

The present application claims priority from a provisional application Ser. No. 61/837,528, entitled “METHOD AND APPARATUS FOR IMPROVED MULTICAST RATE CONTROL,” filed Jun. 20, 2013, which is commonly owned and incorporated herein by reference in its entirety.

This application is related to a co-pending application Ser. No. 12/962,362, entitled “METHOD AND APPARATUS FOR IMPROVED MULTICAST SERVICE,” filed Dec. 7, 2010, which is commonly owned and incorporated herein by reference in its entirety.

This application is related to a co-pending application Ser. No. 13/031,395, entitled “METHOD AND APPARATUS FOR IMPROVED MULTICAST SERVICE USING FEEDBACK MOBILES,” filed Feb. 21, 2011, which is commonly owned and incorporated herein by reference in its entirety.

This application is related to a co-pending application Ser. No. 13/911,816, entitled “METHOD AND APPARATUS FOR IMPROVED MULTICAST RATE CONTROL USING FEEDBACK MOBILES,” filed Jun. 6, 2013, which is commonly owned and incorporated herein by reference in its entirety.

### FIELD OF THE INVENTION

The present invention relates generally to communications and, in particular, to multicast service in wireless communication systems.

### BACKGROUND OF THE INVENTION

This section introduces aspects that may help facilitate a better understanding of the inventions. Accordingly, the statements of this section are to be read in this light and are not to be understood as admissions about what is prior art or what is not prior art.

Recent years have witnessed a rapid growth of mobile devices such as smart-phones and tablets equipped with wireless local area network (WLAN) interfaces that comply with the WiFi standards. While these devices allow users to access the Internet anywhere anytime, it is not straightforward to serve rich multimedia content, such as video streams, when users are clustered in crowded areas, due to a combination of high bandwidth requirements and a shortage of wireless spectrum. The inability to serve this growing demand for multimedia content using limited resources in crowded areas has prompted several solutions by both industry and academia.

Many of these solutions are typically based on dense deployment of access points (APs) for providing dedicated content delivery to each user. Such solutions, besides requiring considerable capital and operational expenditure, may not meet user expectations, due to extensive interference between adjacent cells.

Current state of the art solutions use IEEE 802.11, leveraging either unicast or multicast data delivery. Commercial solutions rely on streaming content to individual users. With standards such as 802.11ac promising speeds up to 800 Mbps per user using multi-user MIMO, it is theoretically possible to serve video streams to hundreds of users. However, large numbers of neighboring APs lead to hidden terminal problems and this, coupled with increased interference sensitivity stemming from channel bonding, makes the entire solution interference limited.

Another approach for providing multimedia content to a very large group of users leverages multicast services. While, multicast services are supported in most wireless technologies, e.g., LTE and 802.11-based networks (also termed WiFi networks), they are rarely used due to the following limitations. (a) There is no feedback mechanism from the receivers about the quality of the provided service. (b) To lessen the first problem, data transmission is typically done at lowest permitted bit-rate that, which results in very low resource utilization. To address these shortcomings of wireless multicast services, several FEC (forward-error-correction)-based and feedback-based mechanisms have been proposed. However, these mechanisms do not scale well to very large groups.

Thus, new solutions and techniques that are able to address these issues and support rich multimedia content delivery in crowded areas would meet a need and advance wireless communications generally.

### BRIEF DESCRIPTION OF THE DRAWINGS

FIG. 1 is a graph depicting simulation results, signal-to-noise ratio (SNR) verses Packet Delivery Ratio (PDR), for when the data transmission bit-rate is 9 Mpbs.

FIG. 2 is a graph depicting simulation results, SNR vs. PDR, for when the data transmission bit-rate is 12 Mpbs.

FIG. 3 is a graph depicting simulation results, SNR vs. PDR, for when the data transmission bit-rate is 18 Mpbs.

FIG. 4 is a graph depicting simulation results, SNR vs. PDR, for when the data transmission bit-rate is 24 Mpbs.

FIG. 5 is a graph depicting simulation results, SNR vs. PDR, for when the data transmission bit-rate is 36 Mpbs.

FIG. 6 is a graph depicting simulation results, SNR vs. PDR, for when the data transmission bit-rate is 48 Mpbs.

FIG. 7 is a logic flow diagram of functionality performed by a multicast sender in accordance with various embodiments of the present invention.

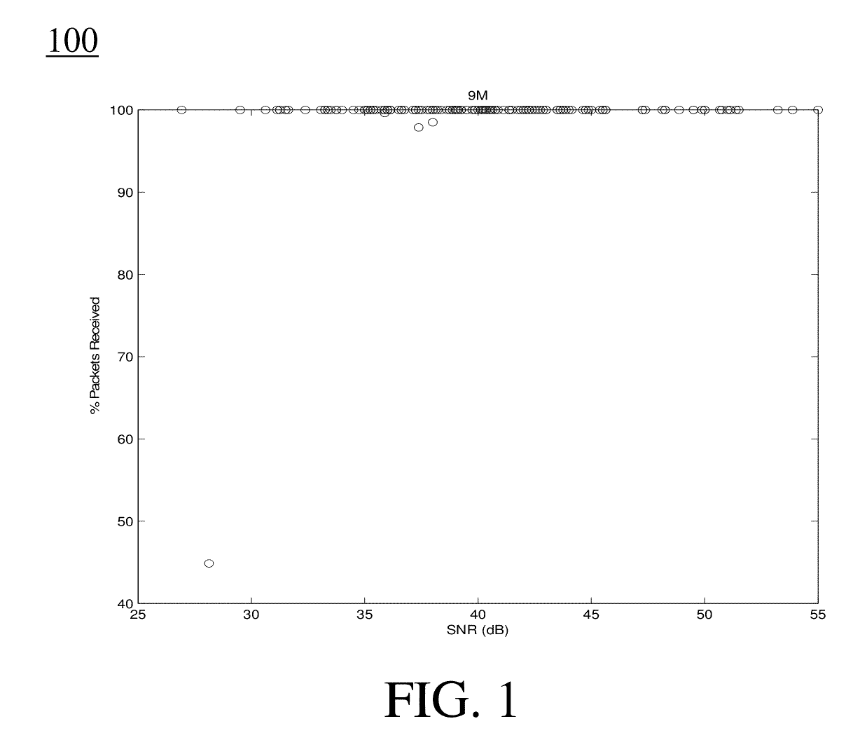

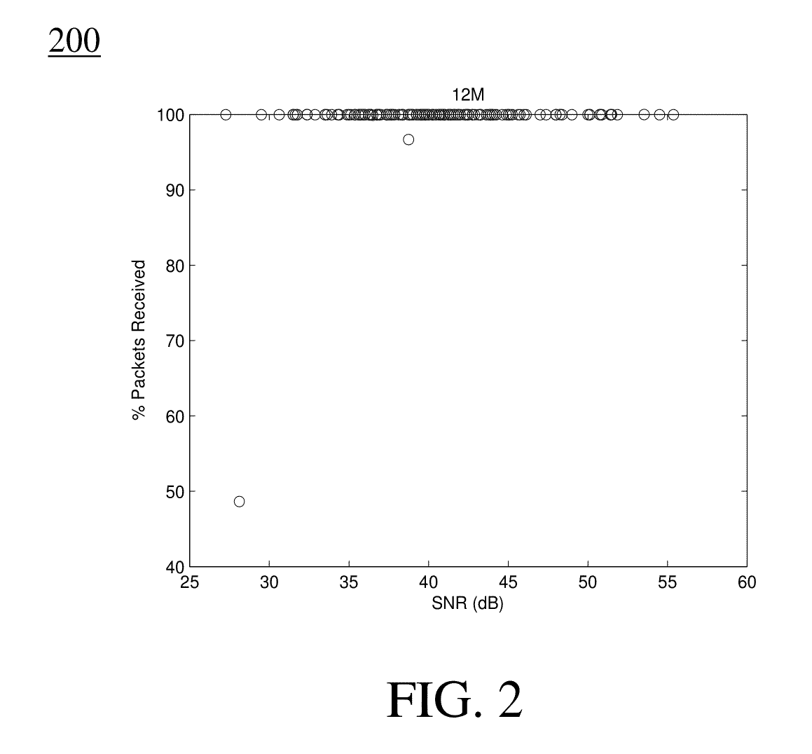

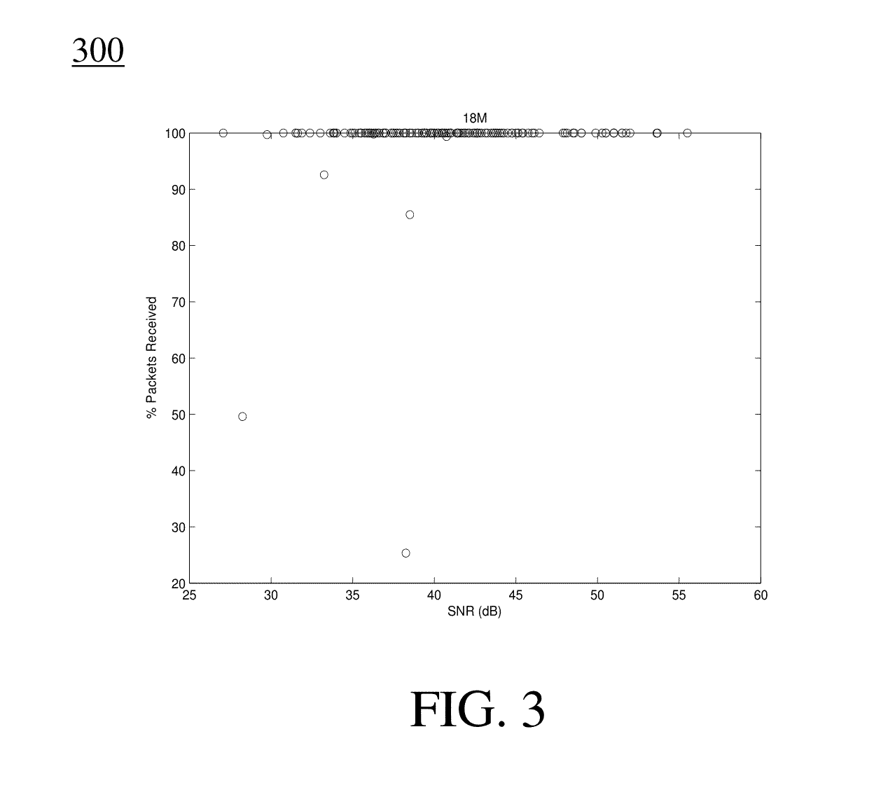

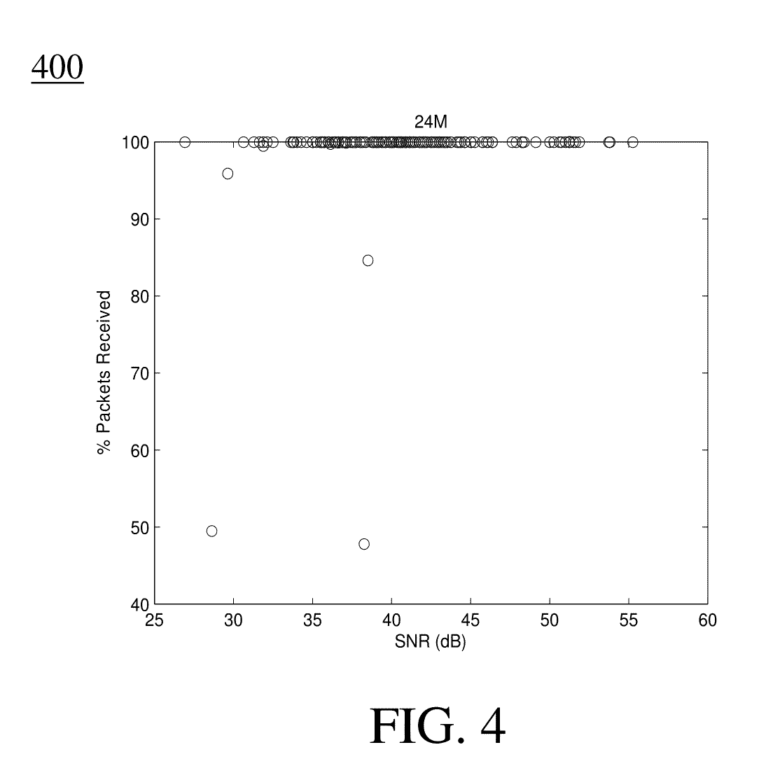

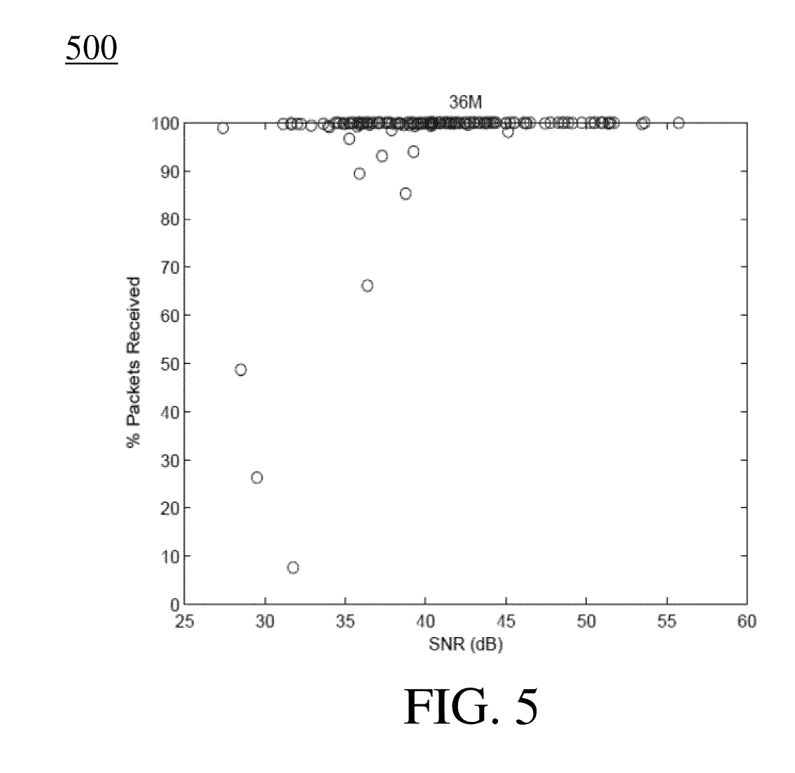

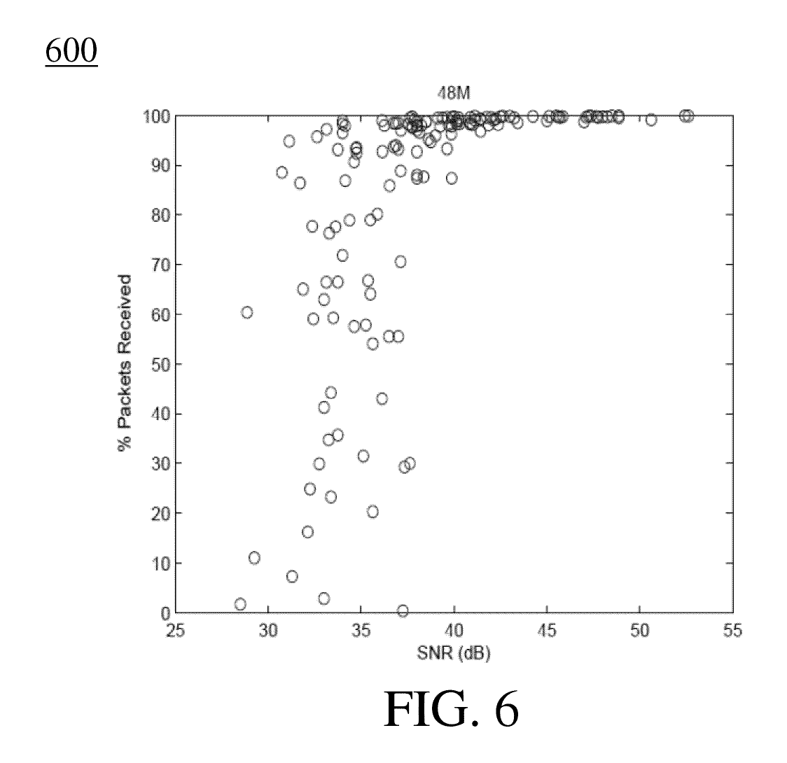

Specific embodiments of the present invention are disclosed below with reference to FIGS. 1-7. Both the description and the illustrations have been drafted with the intent to enhance understanding. For example, the dimensions of some of the figure elements may be exaggerated relative to other elements, and well-known elements that are beneficial or even necessary to a commercially successful implementation may not be depicted so that a less obstructed and a more clear presentation of embodiments may be achieved. In addition, although the logic flow diagrams above are described and shown with reference to specific steps performed in a specific order, some of these steps may be omitted or some of these steps may be combined, sub-divided, or reordered without departing from the scope of the claims. Thus, unless specifically indicated, the order and grouping of steps is not a limitation of other embodiments that may lie within the scope of the claims.

Simplicity and clarity in both illustration and description are sought to effectively enable a person of skill in the art to make, use, and best practice the present invention in view of what is already known in the art. One of skill in the art will appreciate that various modifications and changes may be made to the specific embodiments described below without departing from the spirit and scope of the present invention. Thus, the specification and drawings are to be regarded as illustrative and exemplary rather than restrictive or all-encompassing, and all such modifications to the specific embodiments described below are intended to be included within the scope of the present invention.

### SUMMARY

Various methods and devices are provided to address the need for improved multicast operation. In one method, a sender transmits multicast transmissions at a first transmission rate to a multicast group of mobile devices that includes a group of feedback mobile devices. The sender receives, from each feedback mobile device of the group of feedback mobile devices, multicast receive quality feedback corresponding to the multicast transmissions. A new transmission rate for subsequent multicast transmissions to the multicast group of mobile devices is then determined using the multicast receive quality feedback received from each feedback mobile device, a lower multicast receive quality level threshold and a higher multicast receive quality level threshold. An article of manufacture is also provided, the article comprising a non-transitory, processor-readable storage medium storing one or more software programs which when executed by one or more processors performs the steps of this method.

Many embodiments are provided in which the method above is modified. For example, in many embodiments the sender transmits subsequent multicast transmissions at the new transmission rate to the multicast group of mobile devices. Depending on the embodiment, the multicast receive quality feedback that is received by the sender from each feedback mobile device of the group of feedback mobile devices may comprise an indication of a packet delivery ratio corresponding to the multicast transmissions.

In some embodiments, determining the new transmission rate involves selecting the new transmission rate to be lower than the first transmission rate when the multicast receive quality feedback received from each feedback mobile device collectively indicates that a first threshold portion of the multicast group of mobile devices is experiencing a multicast receive quality level below the lower multicast receive quality level threshold. Also depending on the embodiment, determining the new transmission rate may involve selecting the new transmission rate to be higher than the first transmission rate when the multicast receive quality feedback received from each feedback mobile device collectively indicates that a second threshold portion of the multicast group of mobile devices is experiencing a multicast receive quality level above the higher multicast receive quality level threshold.

A transceiver node apparatus is also provided. The transceiver node includes a transceiver and a processing unit, communicatively coupled to the transceiver. The processing unit is configured to transmit via the transceiver multicast transmissions at a first transmission rate to a multicast group of mobile devices that includes a group of feedback mobile devices and to receive, via the transceiver from each feedback mobile device of the group of feedback mobile devices, multicast receive quality feedback corresponding to the multicast transmissions. The processing unit is also configured to determine a new transmission rate for subsequent multicast transmissions to the multicast group of mobile devices using the multicast receive quality feedback received from each feedback mobile device, a lower multicast receive quality level threshold and a higher multicast receive quality level threshold. Many embodiments are provided in which this transceiver node is modified. Examples of such embodiments can be found described above with respect to the method.

### DETAILED DESCRIPTION OF EMBODIMENTS

To provide a greater degree of detail in making and using various aspects of the present invention, a description of our approach to improving multimedia content delivery and a description of certain, quite specific, embodiments follows for the sake of example. FIGS. 1-6 are referenced to provide some examples of specific simulation results that illustrate the problems that specific embodiments of the present invention may solve.

In related application Ser. Nos. 12/962,362 and 13/031,395, we attempt to address the lack of a feedback mechanism in wireless multicast transmission by selecting a few of the receivers as feedback (FB) nodes to report to the multicast sender/transceiver node (e.g., base station or access point) regarding the quality of the received multicast service. Based on these reports the base station tunes the multicast transmission parameters. For instance, the base station may change the data transmission bit-rate (termed data rate), add FEC (forward-error-correction) codes, etc.

Our recent experiments show that even in controlled environments, a few of the nodes may suffer from poor service quality, while the vast majority of the nodes experience excellent service. We refer to these nodes as abnormal nodes, or outliers, and they typically report very low signal-to-noise ratio (SNR) or Packet Delivery Ratio (PDR). Unfortunately, these negligible number of abnormal nodes are typically selected as the FB nodes, due to the poor service quality that they experience. As a result, the system may operate at a very low data rate to satisfy the outlier/abnormal nodes while compromising the network utilization and significantly reducing the amount and quality of multimedia content that can be provided by the system.

We present a light-weight solution for scalable delivery of rich multimedia content to a large number of users in a small geographical region by means of WiFi multicast or cellular multicast. Our solution is an attractive method for delivering live video content to a large user population that share common interests. For instance, in a sports arena, our approach can be used for providing simultaneous video feeds of multiple camera angles.

In order to use wireless multicast to efficiently transmit a data stream to mobile nodes (mobile devices), the wireless base station (i.e., multicast sender transceiver node) dynamically adjusts the transmission data rate such that the majority of the mobile nodes receive an adequate amount of data (for example, at least a certain percentage, typically 95%, of the packets). The base station (transceiver node) in the wireless system may be an Access Point (AP) in WiFi or a Base Station (BS) in cellular networks, for example.

There are various metrics each mobile node can rely on to measure the quality of received multicast data. The following list contains metrics based on information from different protocol layers:
(1) PHY layer receiver signal to noise ratio (SNR),
(2) Bit Error Rate (BER) based on PHY layer information reported to MAC layer,
(3) MAC level frame reception statistics, and
(4) Packet Data Rate or Packet Delivery Ratio at IP layer
   To build our multicast system without relying on access to the PHY layer or MAC layer, Packet Delivery Ratio (PDR) is chosen as the indicator for the quality of the multicast reception at each mobile node.

It is a well established fact that wireless multicast channel quality varies with time, mobile location, and interference among other factors. Therefore, it is necessary to periodically determine the quality of the multicast reception at mobile nodes in order for the base station to adjust the multicast transmission rate. The goal of the multicast rate adjustment is for a majority (for example, at least 95%) of the mobile nodes to receive the multicast stream with a PDR value above a certain threshold S (for example, S=95%) such that mechanisms at layers higher than the IP layer can deal with the missing packets effectively. Depending on the application that uses the multicast data, higher layer mechanisms may be performing one or more of the following:
(1) Adding Forward Error Correction (FEC) to the higher layer protocol
(2) Relying on multimedia encoding techniques that can tolerate packet losses
(3) Packet retransmission

In light of the above understanding of the nature of wireless multicast, service providers would likely structure their service level agreements (SLAs) as follows: The multicast service is guaranteed to use an adequate transmission bit rate such that at most X % of all mobile nodes in the multicast group will experience PDR lower than S. (In other words, at least (100−X) % of the nodes observe PDR equal to or greater than S.) In order to offer this type of SLA, the multicast BS should periodically receive PDR statistics from mobile nodes in the multicast group and dynamically adjust its transmission data rate.

A simpler yet similar problem exists in unicast transmission where the BS adjusts its data transmission rate to an individual mobile node based on a report of channel conditions from the BS to the mobile node. In this case, the only input to the data rate adjustment mechanism is the channel condition from the BS to exactly one mobile node.

Dynamic bit-rate adaptation is a well-studied topic for unicast transmission in WLAN. It is either based on a transmission quality indicator (frame loss or signal strength of signal-to-noise ratio) at the receiver of the unicast transmission. See e.g., S. Biaz, S. Wu, “Rate Adaptation Algorithms for IEEE 802.11 Networks: A Survey and Comparison”, in Proceedings of IEEE Symposium on Computers and Communications, 2008. In general, when the transmission quality indicator is below some threshold, the sender of the unicast transmission will decrease the transmission bit-rate, while when the indicator is above some threshold value, the sender will increase the transmission bit-rate. Various techniques differ in how to determine the threshold values and how to increase or decrease the transmission bit-rate. A subset of all these techniques also rely on Acknowledgement frames in WLAN and RTS/CTS frames to infer what happened to the transmitted frame. Because multicast does not have acknowledgement or RTS/CTS frames, these techniques cannot be applied in a multicast setting.

For unicast rate adjustment, the only input to the data rate adjustment mechanism is the channel condition from the BS to exactly ONE mobile node. Unlike the unicast transmission rate, in multicast transmission, the bit rate should be adapted to satisfy (100−X) %, or e.g. 95%, of the receivers while getting receiver quality feedback reports only from a few FB nodes. In order to apply a technique for unicast transmission bit-rate adaptation to a multicast setting, one needs to determine what the transmission quality indicator is. For multicast, how to collect PDR values (we'll use PDR in this example) from a large number of receivers, and what PDR value should be chosen as the representative for the entire group is still an open question.

In designing an adaptive multicast transmission bit-rate mechanism, two fundamental problems are addressed:

1. Detection of outliers—We define a multicast receiver as an “outlier” (also termed an abnormal node) if it suffers from poor multicast service quality while the vast majority of the receivers experience high service quality (our experiments with WiFi multicast clearly demonstrate the existence of outliers in a multicast group). Detection of these outliers is key to ensuring that the multicast system meets the SLA requirements, and in related application Ser. No. 13/911,816, we present an efficient mechanism for detecting such receivers.

2. Dynamic Bit-Rate Adaptation—After ignoring the PDR reports from the outliers, the multicast system performs a dynamic bit-rate adaptation operation to maximize the network utilization while meeting the SLA requirements. This challenge is the goal here. The multicast system provides two basic mechanisms:
Fast transmission bit-rate reduction operation—This operation deals with an increasing interference level or movement of the receivers, for example. Notice that the bit-rate reduction operation should not be triggered by the outliers. That is, receiver quality reports from outliers do not influence the decision by a base station to reduce the transmission bit-rate.
Graceful bit-rate increase operation—This operation seeks to maximize the multicast system utilization. Obviously, by increasing the bit-rate, some of the receivers in the multicast group may suffer from lower PDR than the given threshold S (e.g., S=95%) specified by the SLA requirements. Thus before increasing the bit-rate, the system should estimate the number of affected receivers (the nodes whose PDR will drop below S=95% after the rate increase) and increase the bit-rate only if this number is aligned with the SLA requirements (for instance, no more than 5%).

The two operations together attempt to ensure that the system converges quickly to a proper bit-rate that maximizes the network utilization and meets the SLA requirement without causing bit-rate oscillations. This work focuses on the challenge of Dynamic Bit-Rate Adaptation.

We study the problem of PDR value selection and dynamic transmission bit-rate adjustment under the following model:
(1) The BS has the group membership information. 3GPP and 3GPP2 standard specifications have provided mechanisms using Internet Group Management Protocol (IGMP) for the cellular network to track group membership changes through join and leave operations. IGMP may also be added to the IEEE 802.11 WLAN standard for group membership management. See S. Cocorada, Improving Multicast Group Management in IEEE 802.11 Wireless Networks, In Proc. Of Optimization of Electrical and Electronic Equipment (OPTIM) 2008.
(2) Each mobile node within the multicast group continuously calculates its received PDR.
(3) Each mobile node has the ability to establish a unicast channel with the BS and send a message to the BS.
(4) The BS determines what to do with its multicast transmission rate based on the received PDR values.

One design is for each mobile node to send its PDR value to the BS periodically. Based on the list of PDR values from all group members, the BS can easily identify the nodes with the lowest PDR value and verify that at most X % of the nodes suffer from PDR below S. As the next step, the BS can adjust its multicast transmission data rate to the threshold value S such that at most X % of all mobile nodes in the group experience PDR values lower than S, which satisfies the SLA. However, the design that requires each mobile node to periodically report its PDR back to the BS is not scalable as the group size grows.

FIGS. 1-6 demonstrate outliers or abnormal (ABN) nodes in the case of a 802.11-a network with over 150 receivers and a single transceiver node/access point (AP). These figures show the PDR vs. the SNR for different bit-rates between 9 Mbps to 48 Mbps. In all the figures we observe repeatable patterns. In graphs 100, 200, 300 and 400 (data rate of 9-24 Mbps), we notice a few nodes (less than 5) always report significantly lower PDR than the rest of the multicast receivers. The identity and location of these nodes vary from test to test and vary under different multicast transmission data rates. In graphs 500 and 600, we notice that the number of nodes with low PDR increases significantly for data rates of 36 Mbps and 48 Mbps.

We solve the PDR value selection problem under the framework of Feedback (FB) nodes. We have derived a mechanism for mobile nodes to organize themselves around neighborhoods based on their proximity to one another. See e.g., related application Ser. Nos. 12/962,362 and 13/031,395. A mobile node that experiences the lowest PDR value among all its neighbors with a distance at most D becomes a FB node. Only a FB node reports its PDR value to the BS periodically. Any mobile node with a distance less than or equal to D from a reference mobile node is called “D-adjacent” to the reference mobile node. We assume the location of each mobile node in the multicast group is periodically updated at the BS. For our needs we assume that the D parameter value used for determining the D-adjacent of each FB node is configurable and individual such that each FB node may be associated with its own D parameter value.

One key is for the BS to examine the PDR values reported from all the FB nodes and iteratively mark certain FB nodes as “abnormal (ABN)” under an “abnormity test.” The marking process stops either when at least X % of all mobile nodes in the group have been marked as abnormal, or the abnormity test returns false. At the end of this process, we are guaranteed to mark at most X % of all mobile nodes in the group as abnormal. See e.g., related application Ser. No. 13/911,816.

To simplify our discussion we will assume that the SLA requirements are as follows: “At most X=5% of the nodes should have PDR lower than S=95%.” We define two thresholds (H_low and H_high) that are used by a base station to make the decision of whether to reduce or increase the multicast transmission bit-rate. For the sake of discussion, the following example values will be used:

H_low=S=95%—The base station reduces the multicast transmission bit-rate if more than X % of the receivers experience PDR below H_low=95%.

H_high=98%—The base station increases the multicast transmission bit-rate if no more than X % of the receivers experience PDR below H_high=98%. In this case the expectation is that after such bit-rate increase at least (100−X) %=95% of the receivers will experience PDR above H_low=S=95%.

The multicast system can be in one of the following situations when considering the PDR values of all receivers in the multicast group. Let X_P be the X-percentile value of the PDRs experienced by each receiver in the multicast group. We use the terms receiver and node interchangeably.

Case I—The X-percentile value of all the PDRs is less than H_low. That is, X_P<H_low. This means more than X % of the receivers suffer from PDR below H_low=S=95%. In this case, the system activates the fast transmission bit-rate reduction operation. The challenge in this case is to detect that more than X % of the nodes suffer from low PDR without collecting the PDR values from all the nodes.

Case II—The X-percentile value of all the PDRs is more than H_high. That is, X_P>H_high. This means more than X % of the nodes experience high PDR above H_high=98%. In this case, the system activates the graceful bit-rate increase operation. The challenge here is to predict whether more than (100−X) % of the nodes will continue to experience PDR value above H_low=S=95% after the multicast bit-rate increase.

Case III—The (100−X)-percentile value of all the PDRs between H_low and H_high inclusive. That is, H_low<=X_P<=H_high. Less than X % of the nodes suffer from low PDR below H_low=S=95%, however, more than X % of the nodes experience PDR below H_high=98%. Consequently, the system stays with the same transmission bit-rate.

A multicast receiver can assume one of the following roles:
FB node—a FB node represents its neighborhood of radius D. A FB node reports its PDR to the base station.
Outlier node or abnormal (ABN) node—an outlier only represents itself. It represents a neighborhood with radius D=0. It reports its PDR to the base station. It should satisfy the two conditions below in its definition.
Non-FB node or regular node—a regular node is represented by its FB node. It does not report its PDR to the base station.

We define D_default>0 as the default D-adjacency range of a FB node. We define D_{—}0=0 as the a D-adjacency range of a node representing itself. Note that this type of node can be considered a FB node with 0-adjacency range. For clarity, we do not call them FB nodes. We define a node as an outlier node if the node meets both of the following two conditions: the node experiences PDR below H_low=S=95% and the node experiences a PDR value less than X-percentile value of PDR values of all receivers in the group (X_P) where X=5% in our example. Since the outlier nodes represent only themselves, the system contains FB nodes with PDR values >S=95% that represent all the other receivers in our example.

Note that once an outlier node starts reporting a PDR value above S=95%, it is immediately considered a FB node with 0-adjacency range and is removed from the lists of outliers. Now to reduce the number of FB nodes, the system can associate to such nodes a parameter D=D_Default. As a result, some of the FB nodes may observe that there are other FB nodes with lower PDR in their vicinities and they may stop serving as FB nodes.

### Fast Transmission Bit-Rate Reduction Operation

This operation is triggered when some of the FB nodes report reduction of their PDR values. Since such an event may occur due to interference, a quick response is required. On the other hand, we don't want to reduce the bit-rate only if an insignificant number of nodes experience some reduction of their PDR values. Therefore, we propose the following criteria as the trigger for reducing the multicast bit-rate:

1—The system should detect that at least X % of the nodes with PDR below S=95%. In other words, the X-percentile of PDR values of all nodes is less than

S=95%. By definition, these nodes are either outliers or some FB nodes that report reduction of their PDR values.

2—We define a value K (typically between 3-5) and a time interval T_reduce (for example, 500 ms). The system reduces the multicast bit-rate only if at least K FB nodes report reduction of their PDR values (from above S=95% to a value below S=95%) during a period of T_reduce.

To determine whether these two conditions are met, a protocol can be implemented between the receivers and the base station. On the receiver side, once each FB node (with PDR value >S=95%) detects a drop of its PDR value, it reports the drop to the base station. As each FB node periodically reports its PDR to the base station, this requirement can be met. For the first condition above, the base station counts the number of nodes that report a PDR value below 95% (outliers and FB nodes). Note that an outlier reports its PDR to the base station periodically. If K or more FB nodes report low PDR during a time period T_reduce then the system reduces the multicast bit-rate (second condition met). Otherwise, it just defines these FB nodes as outliers and the new outliers are associated with D-adjacency parameter D=D0 (=0). As a result, some nodes in the vicinity of these new outliers volunteer to serve as FB nodes, which helps the system to evaluate whether the two conditions above are satisfied.

### Graceful Bit-Rate Increase Operation

Typically after increasing the multicast bit-rate some nodes suffer from reduction of their experienced PDR. The challenge here is to estimate the number of receivers that will suffer from a low PDR below S=95% due to such operation before the base station actually increases the multicast bit-rate. Assume that all the nodes with H_low <PDR <H_high (=98% in our example) will suffer from PDR<H_low (=95% in our example) after the base station increases the multicast bit-rate. Therefore, before the base station increases the bit-rate, it should verify that the number of receivers with PDR <H_high is at most X % of all the receivers in the group. This verification may conducted as follows:

(a) If all the FB nodes (that report PDR >H_low=95%) also report PDR >H_high=98% then there are no receivers in the range (H_low, H_high) and the multicast bit-rate will be increased to the next available rate.

(b) Else, there are some FB nodes that report PDR<H_high=98%. If the number of these FB nodes plus the outliers is at least X % of the receivers, then the base station keeps the same bit-rate.

(c) Otherwise, there are some FB nodes with PDR<H_high=98%, but the number of FB nodes and outliers with PDR <H_high=98% is less than X % of all the receivers. Observe that in this case, the multicast group may contain additional non-FB node receivers that suffer from PDR <H_high=98% that are represented by some FB nodes. So before increasing the bit-rate, the base station should verify that the total number of receivers with PDR <H_high=98% is at most X %. To check this condition the base station performs the following process: It identifies the FB node(s) with PDR >H_low=95% with the minimal PDR (PDR <H_high=98%). For example, node u is such a node. The base station considers u as an outlier. That is, the base station assigns the D-adjacency parameter D=D0=0 to node u. Consequently, some of the D_default—adjacent nodes of node u became FB nodes. After this step, the base station returns to step (a).

(d) After performing step (c) one or more times, one of the following two situations occurs:
All the FB nodes have PDR >H_high=98% and the system increases the multicast bit-rate [done in step (a)]. OR
The number of outliers plus FB nodes with PDR <H_high=98% constitute at least X % of all the receivers, [as done in step (b)] and the base station keeps the same bit-rate. After deciding to keep the same bit-rate the base station simply switches all the outliers with PDR >H_low=95% back to FB nodes with D=D0=0. As described above, to reduce the number of FB nodes the system can associate to FB nodes with D=Do a new value D=D_Default. As a result, some of the FB nodes may observe that there are other FB nodes with lower PDR values in their vicinities, and they may cease serving as FB nodes.

### System Stability

Our rate-adaptation mechanism should ideally prevent oscillations due to frequent changes of the multicast bit-rate and should converge quickly to the appropriate bit-rate. Below we present some options to further this goal.

Oscillations occur when both rate reduction and rate increase operations are done too frequently. To avoid this problem we propose a time interval T_stable to specify the minimal time period between bit-rate reduction and increase operations. This allows fast reduction of the bit-rate when needed and fast increase of the bit-rate when the bit-rate is too low.

A potential reason for bit-rate oscillations is frequent changes of the PDR reports by the FB nodes. Some of the FB nodes may send multiple reports both above and below the H_low threshold causing frequent changes to the multicast bit-rate. To avoid such situations, we propose to use exponential smoothing that averages the recent PDR reports of each FB node, such that a single change of a node PDR will not trigger a change of the multicast bit-rate.

Another concern is frequent changes to the set of FB nodes as nodes may suffer from some variation of their PDR values. To address this problem, the following combination is proposed. Each receiver should perform exponential smoothing on its PDR values. We define a margin M (e.g. M=3%) and a node volunteers to serve as FB nodes only if its average PDR value is at least M-percent below the reported PDR value of its D-adjacent FB node.

Finally, we propose minimum steps for bit-rate change. When the base station increases its bit-rate, it should use the next available value higher than the current value, and when it decreases its bit-rate, it should decrease to the next available value lower than the current value. When the base station starts transmitting with an initial bit-rate, it should start with the bit-rate in the middle of the available bit-rate range. This mechanism will reduce the number of potential rate increases and decreases in a range of conditions.

The detailed and, at times, very specific description above is provided to effectively enable a person of skill in the art to make, use, and best practice the present invention in view of what is already known in the art. In the examples, specifics are provided for the purpose of illustrating possible embodiments of the present invention and should not be interpreted as restricting or limiting the scope of the broader inventive concepts.

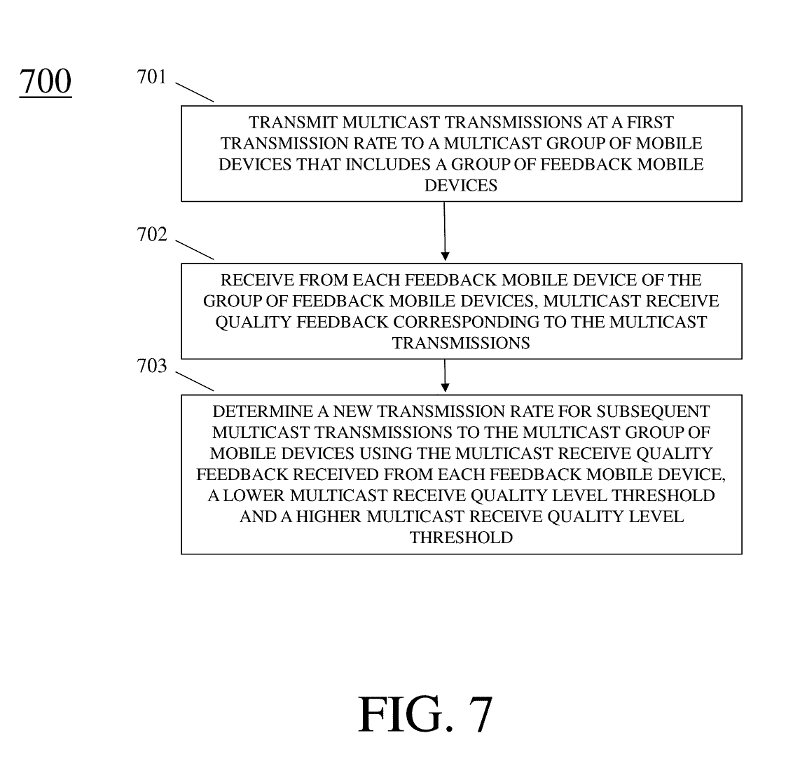

Aspects of embodiments of the present invention can also be understood with reference to FIG. 7. Diagram 700 of FIG. 7 is a logic flow diagram of functionality performed by a multicast sender in accordance with various embodiments of the present invention. In the method depicted in diagram 700, a sender transmits (701) multicast transmissions at a first transmission rate to a multicast group of mobile devices that includes a group of feedback mobile devices. The sender receives (702), from each feedback mobile device of the group of feedback mobile devices, multicast receive quality feedback corresponding to the multicast transmissions. A new transmission rate for subsequent multicast transmissions to the multicast group of mobile devices is then determined (703) using the multicast receive quality feedback received from each feedback mobile device, a lower multicast receive quality level threshold and a higher multicast receive quality level threshold.

Many embodiments are provided in which the method above is modified. For example, in many embodiments the sender transmits subsequent multicast transmissions at the new transmission rate to the multicast group of mobile devices. Depending on the embodiment, the multicast receive quality feedback that is received by the sender from each feedback mobile device of the group of feedback mobile devices may comprise an indication of a packet delivery ratio corresponding to the multicast transmissions.

In some embodiments, determining the new transmission rate (as in 703, e.g.) involves selecting the new transmission rate to be lower than the first transmission rate when the multicast receive quality feedback received from each feedback mobile device collectively indicates that a first threshold portion of the multicast group of mobile devices is experiencing a multicast receive quality level below the lower multicast receive quality level threshold. Also, depending on the embodiment, determining the new transmission rate (as in 703, e.g.) may involve selecting the new transmission rate to be higher than the first transmission rate when the multicast receive quality feedback received from each feedback mobile device collectively indicates that a second threshold portion of the multicast group of mobile devices is experiencing a multicast receive quality level above the higher multicast receive quality level threshold.

The operation of a multicast sender, such as described with respect to diagram 700, may be performed by a transceiver node apparatus that includes a transceiver and a processing unit, communicatively coupled to the transceiver. The processing unit is configured to transmit via the transceiver multicast transmissions at a first transmission rate to a multicast group of mobile devices that includes a group of feedback mobile devices and to receive, via the transceiver from each feedback mobile device of the group of feedback mobile devices, multicast receive quality feedback corresponding to the multicast transmissions. The processing unit is also configured to determine a new transmission rate for subsequent multicast transmissions to the multicast group of mobile devices using the multicast receive quality feedback received from each feedback mobile device, a lower multicast receive quality level threshold and a higher multicast receive quality level threshold. Many embodiments are provided in which this transceiver node is modified.

In general, components such as processing units and transceivers in a transceiver node apparatus are well-known. For example, processing units are known to comprise basic components such as, but neither limited to nor necessarily requiring, microprocessors, microcontrollers, memory devices, application-specific integrated circuits (ASICs), and/or logic circuitry. Such components are typically adapted to implement algorithms and/or protocols that have been expressed using high-level design languages or descriptions, expressed using computer instructions, expressed using signaling flow diagrams, and/or expressed using logic flow diagrams.

Thus, given a high-level description, an algorithm, a logic flow, a messaging/signaling flow, and/or a protocol specification, those skilled in the art are aware of the many design and development techniques available to implement a processing unit that performs the given logic. Therefore, the transceiver node apparatus represents a known device that has been adapted, in accordance with the description herein, to implement multiple embodiments of the present invention. Furthermore, those skilled in the art will recognize that aspects of the present invention may be implemented in and across various physical components and none are necessarily limited to single platform implementations. For example, the processing unit may be implemented in or across one or more network components.

A person of skill in the art would readily recognize that steps of various above-described methods can be performed by programmed computers. Herein, some embodiments are intended to cover program storage devices, e.g., digital data storage media, which are machine or computer readable and encode machine-executable or computer-executable programs of instructions where said instructions perform some or all of the steps of methods described herein. The program storage devices may be, e.g., digital memories, magnetic storage media such as a magnetic disks or tapes, hard drives, or optically readable digital data storage media. The embodiments are also intended to cover computers programmed to perform said steps of methods described herein.

Benefits, other advantages, and solutions to problems have been described above with regard to specific embodiments of the present invention. However, the benefits, advantages, solutions to problems, and any element(s) that may cause or result in such benefits, advantages, or solutions, or cause such benefits, advantages, or solutions to become more pronounced are not to be construed as a critical, required, or essential feature or element of any or all the claims.

As used herein and in the appended claims, the term “comprises,” “comprising,” or any other variation thereof is intended to refer to a non-exclusive inclusion, such that a process, method, article of manufacture, or apparatus that comprises a list of elements does not include only those elements in the list, but may include other elements not expressly listed or inherent to such process, method, article of manufacture, or apparatus. The terms a or an, as used herein, are defined as one or more than one. The term plurality, as used herein, is defined as two or more than two. The term another, as used herein, is defined as at least a second or more. Unless otherwise indicated herein, the use of relational terms, if any, such as first and second, top and bottom, and the like are used solely to distinguish one entity or action from another entity or action without necessarily requiring or implying any actual such relationship or order between such entities or actions.

The terms including and/or having, as used herein, are defined as comprising (i.e., open language). The term coupled, as used herein, is defined as connected, although not necessarily directly, and not necessarily mechanically. Terminology derived from the word “indicating” (e.g., “indicates” and “indication”) is intended to encompass all the various techniques available for communicating or referencing the object/information being indicated. Some, but not all, examples of techniques available for communicating or referencing the object/information being indicated include the conveyance of the object/information being indicated, the conveyance of an identifier of the object/information being indicated, the conveyance of information used to generate the object/information being indicated, the conveyance of some part or portion of the object/information being indicated, the conveyance of some derivation of the object/information being indicated, and the conveyance of some symbol representing the object/information being indicated.

What is claimed is:

1. A method for improved multicast rate control, the method comprising:
transmitting by a sender multicast transmissions at a first transmission rate to a multicast group of mobile devices that includes a group of feedback mobile devices;
receiving, by the sender from each feedback mobile device of the group of feedback mobile devices, multicast receive quality feedback corresponding to the multicast transmissions;
determining a new transmission rate for subsequent multicast transmissions to the multicast group of mobile devices using the multicast receive quality feedback received from each feedback mobile device, a lower multicast receive quality level threshold and a higher multicast receive quality level threshold.

2. The method of claim 1, wherein determining the new transmission rate comprises
selecting the new transmission rate to be lower than the first transmission rate when the multicast receive quality feedback received from each feedback mobile device collectively indicates that a first threshold portion of the multicast group of mobile devices is experiencing a multicast receive quality level below the lower multicast receive quality level threshold.

3. The method of claim 1, wherein determining the new transmission rate comprises
selecting the new transmission rate to be higher than the first transmission rate when the multicast receive quality feedback received from each feedback mobile device collectively indicates that a second threshold portion of the multicast group of mobile devices is experiencing a multicast receive quality level above the higher multicast receive quality level threshold.

4. The method of claim 1, wherein receiving, by the sender from each feedback mobile device of the group of feedback mobile devices, multicast receive quality feedback corresponding to the multicast transmissions comprises
receiving, from each feedback mobile device of the group of feedback mobile devices, an indication of a packet delivery ratio corresponding to the multicast transmissions.

5. The method of claim 1, further comprising
transmitting by the sender subsequent multicast transmissions at the new transmission rate to the multicast group of mobile devices.

6. A transceiver node of a communication system, the transceiver node comprising:
a transceiver;
a processing unit, communicatively coupled to the transceiver, configured
to transmit via the transceiver multicast transmissions at a first transmission rate to a multicast group of mobile devices that includes a group of feedback mobile devices,
to receive, via the transceiver from each feedback mobile device of the group of feedback mobile devices, multicast receive quality feedback corresponding to the multicast transmissions, and
to determine a new transmission rate for subsequent multicast transmissions to the multicast group of mobile devices using the multicast receive quality feedback received from each feedback mobile device, a lower multicast receive quality level threshold and a higher multicast receive quality level threshold.

7. The transceiver node of claim 6, wherein being configured to determine the new transmission rate comprises
being configured to select the new transmission rate to be lower than the first transmission rate when the multicast receive quality feedback received from each feedback mobile device collectively indicates that a first threshold portion of the multicast group of mobile devices is experiencing a multicast receive quality level below the lower multicast receive quality level threshold.

8. The transceiver node of claim 6, wherein being configured to determine the new transmission rate comprises
being configured to select the new transmission rate to be higher than the first transmission rate when the multicast receive quality feedback received from each feedback mobile device collectively indicates that a second threshold portion of the multicast group of mobile devices is experiencing a multicast receive quality level above the higher multicast receive quality level threshold.

9. The transceiver node of claim 6, wherein being configured to receive, from each feedback mobile device of the group of feedback mobile devices, multicast receive quality feedback corresponding to the multicast transmissions comprises
being configured to receive, from each feedback mobile device of the group of feedback mobile devices, an indication of a packet delivery ratio corresponding to the multicast transmissions.

10. The transceiver node of claim 6, wherein the processing unit is further configured
to transmit via the transceiver subsequent multicast transmissions at the new transmission rate to the multicast group of mobile devices.

11. An article of manufacture comprising a non-transitory, processor-readable storage medium storing one or more software programs which when executed by one or more processors performs the steps of the method comprising:
transmitting by a sender multicast transmissions at a first transmission rate to a multicast group of mobile devices that includes a group of feedback mobile devices;
receiving, by the sender from each feedback mobile device of the group of feedback mobile devices, multicast receive quality feedback corresponding to the multicast transmissions;
determining a new transmission rate for subsequent multicast transmissions to the multicast group of mobile devices using the multicast receive quality feedback received from each feedback mobile device, a lower multicast receive quality level threshold and a higher multicast receive quality level threshold.

12. The article of manufacture of claim 11, wherein determining the new transmission rate comprises
selecting the new transmission rate to be lower than the first transmission rate when the multicast receive quality feedback received from each feedback mobile device collectively indicates that a first threshold portion of the multicast group of mobile devices is experiencing a multicast receive quality level below the lower multicast receive quality level threshold.

13. The article of manufacture of claim 11, wherein determining the new transmission rate comprises
selecting the new transmission rate to be higher than the first transmission rate when the multicast receive quality feedback received from each feedback mobile device collectively indicates that a second threshold portion of the multicast group of mobile devices is experiencing a multicast receive quality level above the higher multicast receive quality level threshold.

14. The article of manufacture of claim 11, wherein receiving, by the sender from each feedback mobile device of the group of feedback mobile devices, multicast receive quality feedback corresponding to the multicast transmissions comprises
receiving, from each feedback mobile device of the group of feedback mobile devices, an indication of a packet delivery ratio corresponding to the multicast transmissions.

15. The article of manufacture of claim 11, wherein the storage medium storing one or more software programs which when executed by one or more processors performs the steps of the method further comprising
transmitting by the sender subsequent multicast transmissions at the new transmission rate to the multicast group of mobile devices.
